(19) United States
(12) Patent Application Publication
(10) Pub. No.: US 2022/0020985 A1
(43) Pub. Date: Jan. 20, 2022

(54) MIXED METAL MANGANESE OXIDE MATERIAL

(71) Applicant: UOP LLC, Des Plaines, IL (US)

(72) Inventors: Stuart R. Miller, Arlington Heights, IL (US); Susan C. Koster, Carpentersville, IL (US); Natalie L. Nicholls, Chicago, IL (US); Elmira Ghanbari, Wheeling, IL (US); John P.S. Mowat, Arlington Heights, IL (US)

(21) Appl. No.: 17/313,248

(22) Filed: May 6, 2021

Related U.S. Application Data
(60) Provisional application No. 63/053,302, filed on Jul. 17, 2020.

(51) Int. Cl. H01M 4/58; C01G 53/00; C01G 45/12; C01B 21/082; H01M 10/054; H01M 4/525; H01M 4/505

(52) U.S. Cl. CPC H01M 4/58; C01G 53/44; C01G 45/12; C01B 21/0821; C01B 21/0828; H01M 10/054; H01M 2004/028; H01M 4/505; C01P 2006/40; C01P 2002/02; C01P 2002/52; C01P 2002/74; C01P 2002/72; H01M 4/525

(57) ABSTRACT

A poorly crystalline mixed metal manganese oxide material. The mixed metal manganese oxide material may be used for making a cathode for a rechargeable battery. Generally, the mixed metal manganese oxide includes: manganese oxide; copper, silver, gold, or a combination thereof; a first additional cation selected from the group consisting of: bismuth, lead, and mixtures thereof; and a second additional cation selected from the group consisting of: lithium, sodium, potassium, cesium, rubidium, beryllium, magnesium, calcium, strontium, barium, NR₄⁺, or a combination thereof, with R being, hydrogen, an alkyl group, an aryl group, or combinations thereof. The amorphous composition has an essentially amorphous x-ray powder diffraction pattern.

### RELATED APPLICATIONS

This application claims priority to U.S. Provisional Patent Application Ser. No. 63/053,302 filed on Jul. 17, 2020, the entirety of which is incorporated herein by reference.

### FIELD OF THE INVENTION

This invention relates generally to the storage of electrical energy, and more particularly to batteries, and even more specifically to a material for a cathode in a battery.

### BACKGROUND OF THE INVENTION

The efficient and cost-effective capture and storage of energy is critically important, in particular, the storage and use of electrical energy has become a cornerstone to our modern lives. From cellular phones and electric vehicles to the continual development, refinement and deployment of energy from renewable sources, electrochemical energy storage plays a pivotal role in our developing world and provides significant market opportunity.

Owing to its relative abundance, low cost, toxicity equilibrium potential, zinc rapidly became a key component in the fabrication of electrochemical cells. Zinc provides the benefit of high energy densities as well as being chemically compatible with aqueous electrolytes. Due to this, the electrochemical properties of zinc have been a long-standing fascination for over 200 years, with one of the first documented occurrences starting with Alessandro Volta, who, in 1798, is credited with the invention of the first true battery, consisting of a stacks of alternating copper and zinc disks separated by a layer of cloth or cardboard soaked in brine.

Since Volta's invention of the Voltaic pile, zinc has been a key component of several different battery technologies, however it was not until 1866 that French electrical engineer Georges Leclanché paired the electrochemical properties of zinc and manganese inventing the Leclanché cell. The Leclanché cell comprises of a zinc anode and a manganese dioxide (and carbon) cathode wrapped in a porous material and dipped in a vessel containing ammonium chloride, providing a voltage ˜1.4V. The Leclanché cell was further modified by German physicist Carl Gassner by mixing ammonium chloride and a small volume of zinc chloride, in plaster of Paris, immobilizing the electrolyte. The manganese dioxide cathode was dipped in the plaster of Paris paste and then encased inside a zinc cell, providing a potential of ˜1.5V. The system was referred to as the dry cell as there was no liquid electrolyte, which enabled the use of the dry cell in any orientation. Taking advantage of low material costs, the dry cell was mass produced until the late 1950s when it was replaced by Union Carbide's innovation, the modern Zn|MnO₂ alkaline battery. Zn|MnO₂ alkaline batteries are considered as primary batteries, i.e. non-rechargeable, as there is an irreversible transformation to the cell upon discharge.

The simplified electrochemical reactions which take place at the anode and the cathode are shown below:

Zn+2OH⁻→ZnO+H₂O+2e⁻ Anode (oxidation)

2MnO₂+H₂O+2e⁻→Mn₂O₃+2OH⁻ Cathode (reduction)

Zn+2MnO₂→ZnO+Mn₂O₃ Overall reaction

The manganese oxide cathode material used in the production of zinc batteries is electrolytic manganese dioxide (EMD) and can also be described as the γ-MnO₂ phase. Historically, the manganese oxide mineral Nsutite, was used as the cathode material in zinc-carbon dry cell batteries, however in recent years production EMD has enabled a more reliable MnO₂ source as well as enhanced performance and stability. Nsutite and EMD are both ingrown pyrolusite/Ramsdellite materials. It has been well demonstrated, the current Zn|MnO₂ batteries are limited in their ability to recharge owing to an irreversible transformation of the MnO₂ phase upon discharge to the dense phases of Mn₂O₃ and Mn₃O₄, a cartoon representation of which is shown in FIG. 1. However, prior to the formation of these phases, it is understood that EMD undergoes as dissolution/recrystallization procedure involving the in-situ crystallization of δ-MnO₂.

Since the invention of the Zn|MnO₂ alkaline battery, there has been considerable efforts to provide a rechargeable solution to enable the recharge and reuse the of cell after the primary discharge. Rechargeable alkaline manganese (RAM) batteries were developed from primary alkaline battery technology and are capable of being recharged for a limited number of cycles at limited depth of discharge. In the 1970s, a collaborative effort between Union Carbide and Mallory resulted in the introduction of the first-generation of rechargeable alkaline batteries. Several companies and academic institutions pursued different routes to establishing rechargeable alkaline manganese oxide technologies however research interest in the area subsided with the commercialization of lithium-ion technology in 1991, a collaborative effort between Sony and Asahi Kasei. Since then lithium-ion batteries (LIBs) have established themselves as technology leaders assuming the dominant market share for rechargeable energy solutions.

For over 25 years, LIBs have cemented themselves as the rechargeable battery of choice, finding applications in technologies as diverse as portable electronics and electric vehicles to large scale energy storage complexes such as the 100-megawatt battery built by Tesla in South Australia.

Today, LIBs remain the rechargeable battery of choice, however there are several factors which bring into question its continued market dominance, including cost, durability and potential safety hazards. Over the last 60 years, Zn|MnO₂ alkaline cells have established themselves as a principle battery technology with an estimated $7.73B in global sales for consumer single use batteries by 2021. Modern Zn|MnO₂ alkaline batteries use cheap, abundant materials (Mn≈$0.45-0.9 kg) (Zn≈$0.45$kg) (K≈$0.1 kg) to provide safe batteries cells which are EPA certified for disposal.

The low material price enables the manufacture of primary Zn|MnO₂ alkaline batteries for $18-25 kWh, which makes them attractive for a variety of potential energy storage solutions if their chemistry could be altered to make them rechargeable.

Therefore, there remains a need for providing a rechargeable battery that utilizes the Zn|MnO₂ chemistry.

### SUMMARY OF THE INVENTION

The present invention provides a novel, poorly crystalline manganese-based mixed metal oxides that are suitable for use as a cathode material for rechargeable batteries. The mixed metal oxides exhibit a poorly crystalline diffraction pattern. By using material that is relatively abundant, has a low toxicity, and which has established manufacturing infrastructure, a rechargeable Zn|MnO₂ battery may be economically produced which is economically competitive to current rechargeable battery alternatives, such as lithium-ion batteries.

Therefore, the present invention may be characterized, in at least one aspect, as providing a unique mixed metal manganese oxide material which may be processed to facilitate the storage of electrical energy-specifically to form a cathode in a battery. The mixed metal manganese oxide material may be characterized by the formula:

AₐB_{b}C_{c}MₓM₁₋ₓO_{y}OH_{z}D_{d}, [Chemical Formula 1]

wherein ‘A’ represents a group I or group II metal or ammonium (NH₄⁺) or an alkyl ammonium ion or a quaternary organic cation equivalent and may be selected from Li, Na, K, Rb, Cs, Be, Mg, Ca, Sr, Ba, NR₄⁺, and combinations of the foregoing, with R being, hydrogen, an alkyl group, an aryl group, or combinations thereof; ‘B’ represents Bi, Pb, and mixtures thereof; ‘C’ represents Cu, Au, Ag, and combinations thereof; ‘M’ represents Ni, Co, Al, Sc, V, Cr, Ce, Zn, and mixtures thereof; wherein D represents a charge balancing anionic species that may include, for example, Cl−, F−, OH−, S²−, HS−, Br−, and combinations thereof.

In Chemical Formula 1, a sum of an average valence of A multiplied by ‘a’, an average valence of B multiplied by ‘b’, an average valence of C multiplied by ‘c’, an average valence of M multiplied by ‘x’, and an average valence of Mn multiplied by (1-x) is equal to a sum of 2y, z, and an average valence of D multiplied by ‘d’. Additionally, ‘a’ in Chemical Formula may vary between 0 to 0.4, ‘b’ may vary between 0 to 0.3; ‘c’ may vary between 0 to 5, and ‘x’ may vary between 0 to 0.5. The composition includes at least two of: A, B, C, and M.

In another aspect, the present invention may be characterized as providing a process for producing the mixed metal manganese oxide material of Chemical Formula 1 by forming a slurry reaction mixture containing sources of protic solvent and sources of Mn, A, B, C and M; reacting the mixture together at elevated temperature with an autogenous pressure and then recovering the poorly crystalline manganese-based mixed metal oxide material. The reaction may be conducted at a temperature of from 10° C. to about 150° C. for a period of time from about 30 minutes to 14 days.

In another aspect, the present invention may be generally characterized as providing a rechargeable battery comprising a housing, an anode material inside the housing, a cathode material inside the housing and electrically separated from the anode material and an electrolyte in the housing, wherein the cathode material comprises Chemical Formula 1.

In still a further aspect, the present invention may be broadly characterized as providing a composition comprising: manganese oxide; copper, silver, gold, or combinations thereof; a first additional cation selected from the group consisting of: bismuth, lead, and mixtures thereof; and a second additional cation selected from the group consisting of: lithium, sodium, potassium, cesium, rubidium, beryllium, magnesium, calcium, strontium, barium, NR₄⁺, with R being, hydrogen, an alkyl group, an aryl group, or combinations thereof.

In yet another aspect, the present invention may be characterized, generally, as providing an amorphous composition comprising: a mixed metal manganese dioxide, wherein the amorphous composition has an essentially amorphous x-ray powder diffraction pattern, showing no Bragg reflections with an I/I₀>1, and only peaks with an I/I₀ less than 0.1 in a range of 54 to 59 2Θ.

In a further aspect, the present invention may be generally characterized as providing a rechargeable battery comprising: a housing; an anode material inside the housing; a cathode material inside the housing and electrically separated from the anode material; and, an electrolyte in the housing, wherein the cathode material comprises: a mixed metal manganese dioxide an essentially amorphous x-ray powder diffraction pattern, showing no Bragg reflections with an I/I₀>1, and only peaks with an I/I₀ less than 0.1 in a range of 54 to 59 2Θ.

Additional aspects, embodiments, and details of the invention, all of which may be combinable in any manner, are set forth in the following detailed description of the invention.

### DESCRIPTION OF THE DRAWINGS

One or more exemplary embodiments of the present invention will be described below in conjunction with the following drawing figures, in which:

FIG. 1 is a representation of the phase transformation which occurs upon cell discharge of a conventional alkaline Zn|MnO₂ battery;

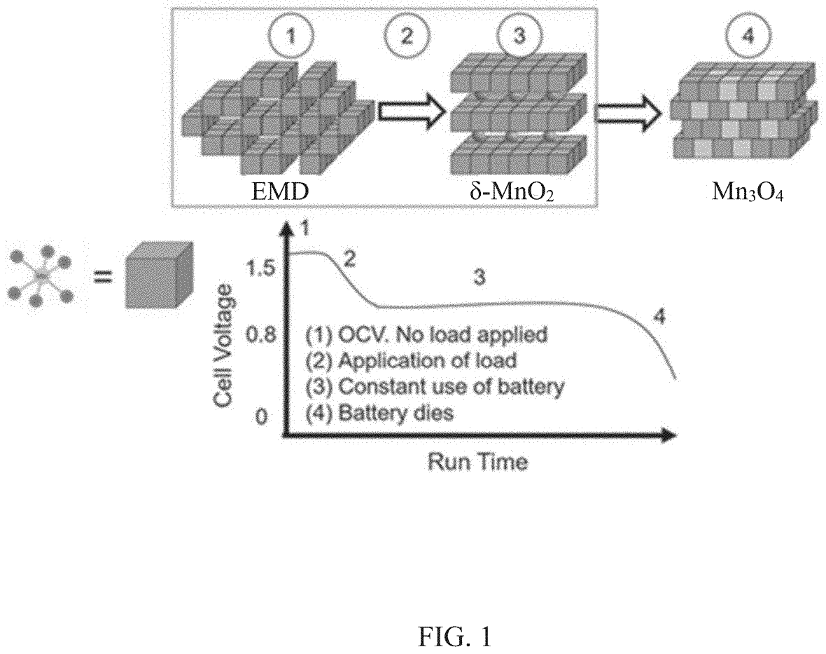

FIG. 2 is a cross sectional view of an embodiment of the battery in a prismatic arrangement; and,

FIG. 3 is an X-ray diffraction pattern of various Examples according to the present invention; and,

FIG. 4 is an X-ray diffraction pattern comparing Examples according to the present invention to electrolytic manganese dioxide (EMD) and Birnessite (delta-MnO₂).

### DETAILED DESCRIPTION OF THE INVENTION

As mentioned above, a novel, poorly crystalline manganese-based mixed material metal oxide has been invented which is believed to provide a superior material for making a cathode for a rechargeable battery. Rechargeable Zn—Mn batteries fabricated using composite cathodes containing the novel, poorly crystalline manganese-based mixed material metal oxide are believed to be capable of thousands of charge-discharge cycles, enabling a safe and economically affordable energy storage system.

Generally, the novel, poorly crystalline manganese-based mixed metal oxides are best prepared by the dissolution and heat treatment of a soluble manganese salt, such as KMnO₄ with other metal components such as the nitrates or oxides of bismuth or copper. Metal precursors are selected either as metal salts (such as the nitrate or chloride), the oxides or hydroxides (such as Bi₂O₃ or Ni(OH)₂).

With these general principles in mind, one or more embodiments of the present invention will be described with the understanding that the following description is not intended to be limiting.

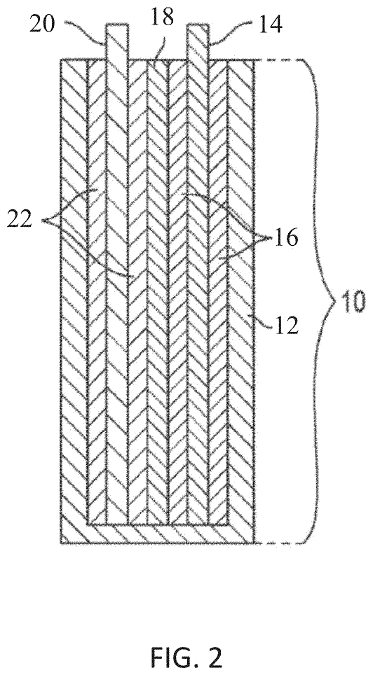

As shown in FIG. 2, a battery 10 according to the present invention may include a housing 12, a cathode current collector 14, a cathode material 16, a separator 18, an anode current collector 20, and an anode material 22. While the battery 10 of FIG. 2 is shown as a prismatic battery arrangement, it is possible that the battery 10 may also be a cylindrical battery.

As is known, dispersed within the housing 12 of the battery 10 is an electrolyte. The electrolyte may be an alkaline electrolyte (e.g. an alkaline hydroxide, such as NaOH, KOH, LiOH, Mg(OH)₂, Ca(OH)₂ or mixtures thereof).

The cathode current collector 14 and the anode current collector 20 may be a conductive material, for example, nickel, nickel-coated steel, tin-coated steel, silver coated copper, copper plated nickel, nickel plated copper or similar material. The cathode current collector 14, the anode current collector 20, or both may be formed into an expanded mesh, perforated mesh, foil or a wrapped assembly.

The separator 3 may be a polymeric separator (e.g. cellophane, sintered polymer film, or a polyolefin material).

As discussed above, the cathode material 16 of the battery 10 according to the present invention comprises a mixed metal manganese dioxide (MnO₂). Various metals and metal combinations have been discovered which may be used as the cathode material 16 with the manganese dioxide. Generally, the cathode material 16 includes: manganese oxide; copper, silver, gold, or combinations thereof; a first additional cation selected from the group consisting of: bismuth, lead, and mixtures thereof; and a second additional cation selected from the group consisting of: lithium, sodium, potassium, cesium, rubidium, beryllium, magnesium, calcium, strontium, barium, NR₄⁺, with R being, hydrogen, an alkyl group, an aryl group, or combinations thereof. The cathode material 16 may also include a third additional cation selected from the group consisting of: nickel, cobalt, aluminum, scandium, vanadium, chromium, cerium, zinc, and mixtures thereof.

Generally, a composition of the cathode material 16 has a chemical formula of:

AₐB_{b}C_{c}MₓM₁₋ₓO_{y}OH_{z}D_{d} [Chemical Formula 1],

In Chemical Formula 1, a sum of an average valence of A multiplied by ‘a’, an average valence of B multiplied by ‘b’, an average valence of C multiplied by ‘c’, an average valence of M multiplied by ‘x’, and an average valence of Mn multiplied by (1-x) is equal to a sum of 2y, z, and an average valence of D multiplied by ‘d’. Additionally, ‘a’ may be in the range of 0 to 0.4, ‘b’ may be in the range of 0 to 0.3, ‘c’ may be in the range of 0 to 5, and ‘x’ may be in the range of 0 to 0.5. The values for these variables are inclusive of the end points of the ranges. As will be appreciated, these values are in relation to the “1” of Mn in Chemical Formula 1. In a preferred embodiment, ‘c’ is in the range of 0 to 0.8.

The composition includes at least two of A, B, C, and M from Chemical Formula 1.

In Chemical Formula 1 ‘A’ is representative of a group I or group II metal or ammonium (NH₄⁺) or an alkyl ammonium ion or a quaternary organic cation equivalent and may be selected from lithium, sodium, potassium, rubidium, cesium, beryllium, magnesium, calcium, strontium, barium, or NR₄⁺, with R being, hydrogen, an alkyl group, an aryl group, or combinations thereof. For example, ‘A’ may be ammonium (NH₄⁺) or an alkyl ammonium ion. ‘B’ in Chemical Formula 1 represents bismuth or lead or combinations thereof. Additionally, ‘C’ in Chemical Formula 1 represents gold, silver, copper, or combinations thereof. ‘M’ in Chemical Formula 1 represents nickel, cobalt, magnesium, aluminum, scandium, vanadium, chromium, cerium, zinc, and mixtures thereof. Finally, ‘D’ in Chemical Formula 1 represents a charge balancing anionic species, for example, fluorine (F⁻), chlorine (Cl⁻), bromine (Br⁻), carbonate (CO₃⁻²), nitrate (NO₃⁻¹), sulfide (S²⁻), bisulfide (HS⁻), or combinations thereof.

Lithium, sodium, potassium, cesium, rubidium, beryllium magnesium, calcium, strontium, barium can be added as salts. Examples include LiMnO₄, NaMnO and KMnO₄.

Bismuth may be incorporated into the cathode material 16 as an inorganic or organic salt of bismuth (oxidation states 5, 4, 3, 2, or 1), as a bismuth oxide, or as elemental bismuth (bismuth metal). Exemplary inorganic bismuth compounds are thought to include bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, triphenylbismuth.

The lead may be incorporated into the cathode material 16 as an inorganic or organic salt of lead (oxidation states 2 or 4), as a lead oxide, or as elemental lead (lead metal). Exemplary inorganic lead compounds are thought to include lead chloride, lead bromide, lead fluoride, lead iodide, lead sulfate, lead nitrate, lead trichloride, lead citrate, lead carbonate, lead acetate, lead trifluoromethanesulfonate, lead nitrate oxide, lead phosphate, lead oxychloride.

The copper may be incorporated into the cathode material 16 as an organic or inorganic salt of copper (oxidation states 1, 2, 3 or 4), as a copper oxide, or as copper metal (i.e. elemental copper). Exemplary copper compounds are thought to be copper and copper salts such as copper aluminum oxide, copper (I) oxide, copper (II) oxide, and copper salts in a +1, +2, +3, or +4 oxidation state such as, copper nitrate, copper sulfate, and copper chloride.

Gold may be incorporated into the cathode material 16 as an inorganic or organic salt of gold (oxidation states 1, 2 or 3), as a gold oxide, or as elemental gold (gold metal). Exemplary inorganic gold compounds are thought to include gold chloride, gold bromide, gold fluoride, gold iodide, gold sulfate, gold nitrate and gold trichloride.

Silver may be incorporated into the cathode material 16 as an inorganic or organic salt of silver (oxidation states 1, 2 or 3), as a silver oxide, or as elemental silver (silver metal). Exemplary inorganic silver compounds are thought to include silver chloride, silver bromide, silver fluoride, silver iodide, silver sulfate, silver nitrate and silver trichloride.

In some embodiments a binder is used to form the cathode material 16 into a cathode. The binder may be present in a concentration of 0-50 wt %. In one embodiment, the binder comprises water-soluble cellulose-based hydrogels, which were used as thickeners and strong binders, and have been cross-linked with good mechanical strength and with conductive polymers. The binder may also be a cellulose film sold as cellophane. The binders may be formed by physically cross-linking the water-soluble cellulose-based hydrogels with a polymer through repeated cooling and thawing cycles. For example, 0-50 wt. % carboxymethyl cellulose (CMC) solution may be cross-linked with 0-50 wt. % polyvinyl alcohol (PVA) on an equal volume basis. The binder, compared to the traditionally-used TEFLON®, is thought to have superior performance. TEFLON® is a very resistive material, but its use in the industry has been widespread due to its good Tollable properties. This, however, does not rule out using TEFLON® as a binder. Mixtures of TEFLON® with the aqueous binder and some conductive carbon may be used to create Tollable binders. The binder may be water-based, is thought to have superior water retention capabilities, adhesion properties, and helps to maintain the conductivity relative to identical cathode using a TEFLON® binder instead. Examples of hydrogels include methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (ELEC). Examples of crosslinking polymers include polyvinyl alcohol, polyvinylacetate, polyaniline, polyvinylpyrrolidone, polyvinylidene fluoride and polypyrrole. For example, a 0-50 wt % solution of water-cased cellulose hydrogen may be cross linked with a 0-50% wt solution of crosslinking polymers by repeated freeze/thaw cycles, radiation treatment or chemical agents (e.g. epichlorohydrin).

Charge balancing anionic species can be incorporated into the cathode material 16 through its addition as part of a salt, with the cation of the salt forming one of the metals in Chemical Formula 1.

The manganese compound may be incorporated into the cathode material 16 as an organic or inorganic salt of manganese (oxidation states 2, 3, 4, 6, or 7+), as a manganese oxide, or as manganese salts in a such as, manganese nitrate, manganese sulfate, manganese chloride, potassium permanganate, sodium permanganate or lithium permanganate.

Hydroxide anions may be incorporated into the cathode material 16 through the incorporation of a base, such as lithium hydroxide, sodium hydroxide, potassium hydroxide, cesium hydroxide, rubidium hydroxide, beryllium hydroxide, magnesium hydroxide, calcium hydroxide, strontium hydroxide, barium hydroxide or organic alternatives such as quaternary ammonium hydroxides.

As noted above, the present mixed metal manganese dioxide material is poorly crystalline. Thus, in contrast to other manganese dioxide materials which can be described as crystalline, the present mixed metal manganese dioxide is “amorphous.” By “amorphous” it is meant that an x-ray powder diffraction pattern showing no very strong Bragg reflections and in particular only vw-w Bragg reflections in the range 54 to 59 2Θ (1.697-1.564 d-spacing) less than 0.1.

Patterns presented in the following examples were obtained using standard x-ray powder diffraction techniques, by mixing 20 wt. % alpha-alumina (corundum structure: Al₂O₃) powder as an internal intensity reference point. To ensure the consistency in the measurement, only a high purity and suitably prepared alumina source must be used. One such choice is the NIST certified Standard Reference Material 676a. Of particular importance is both purity and particle morphology as alumina grains should be sub-micrometer in size and equi-axial in shape to prevent preferred orientation effects when preparing a sample. The radiation source was a high-intensity, x-ray tube operated at 40 kV and 40 mA. The diffraction pattern from the copper K-alpha radiation was obtained by appropriate computer-based techniques. Powder samples were pressed flat into a plate and continuously scanned between 5 degrees and 70 degrees (2Θ). Interplanar spacings (d) in Angstrom units were obtained from the position of the diffraction peaks expressed as theta, where theta is the Bragg angle as observed from digitized data. Intensities were determined from the diffraction peak height after subtracting background, “I₀” being the peak height of the strongest peak of the added internal reference alpha-alumina (corundum structure: Al₂O₃) powder, namely the (113) reflection at 43.35 degrees 2Θ (using Cu Kalpha radiation), and “I” being the peak height for each of the other peaks. As will be understood by those skilled in the art the determination of the parameter 2 theta is subject to both human and mechanical error, which in combination can impose an uncertainty of about +/−0.4 degrees on each reported value of 20. This uncertainty is also translated to the reported values of the d-spacings, which are calculated from the 20 values.

It should be noted and will be understood by those skilled in the art, that when running the scan mixed with corundum as specified above, the Bragg reflections arising from the internal reference are for intensity comparisons only and are not part of the present invention. The expected reflections for the corundum are as follows: Reflection Indices (hkl) and Peak Position (2Θ, degrees using Cu Kalpha radiation) (012) 25.574, (104) 35.149, (110) 37.773, (113) 43.351, (024) 52.548, (116) 57.497 (214) 66.513 (300) 68.203. Of note here is an expected hkl index (116) strong reflection arising from the internal reference in the specified range of 54 to 59 2Θ that should be excluded from the comparisons listed in the claims.

In some of the x-ray patterns reported, the relative intensities of the d-spacings are indicated by the notations s, m, w and vw which represent strong, medium, weak and very weak, respectively. In terms of 100(I/I₀), the above designations are defined as: vw=0.01-5, w=5-10, m=10-50, s=50-100, vs=>100.

In the examples which follow elemental analyses were conducted on air dried samples. Analysis was carried out for all elements except oxygen.

### EXAMPLES

### Example 1

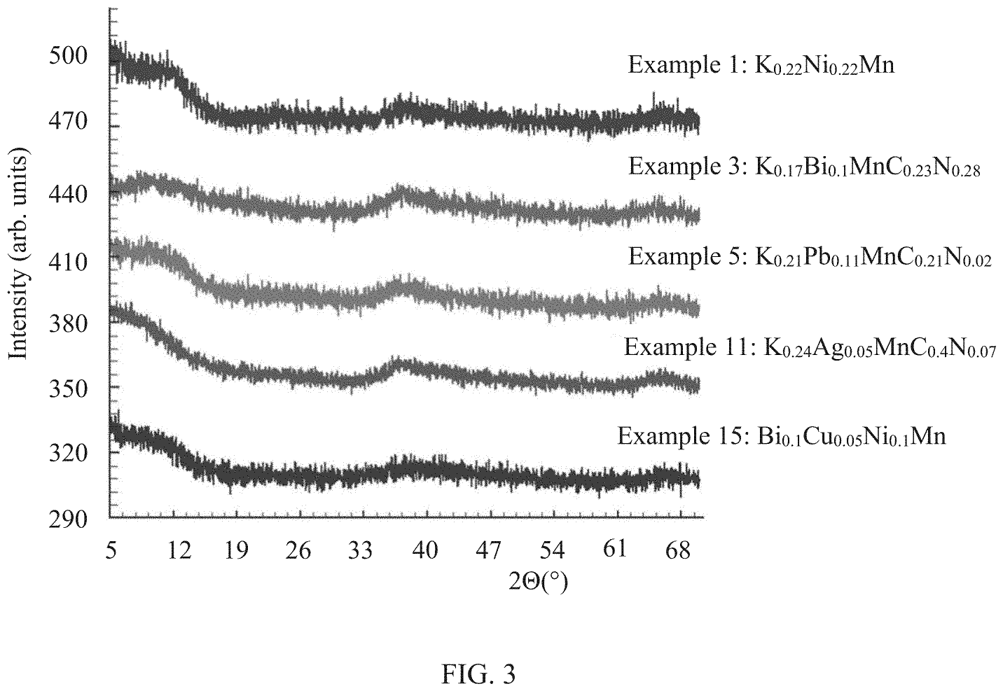

A solution was prepared in a 1 liter Teflon™ bottle by dissolving Ni(NO₃)₂*6H₂O (0.02 moles, 5.81 g) in DI water (0.55 moles, 10 grams), followed by the addition of KMnO₄ (0.1 moles, 15.80 g) and (NH₄)₂CO₃ (0.078 moles, 7.5 g). All reactants were mixed together before the bottle was heated at 65° C. for 16 hours with intermittent venting during the digestion. The obtained slurry was then filtered and washed with DI water (3×100 ml) after which the material was dried at 100° C. Elemental analysis of the final product determined the composition to be K_{0.22}Ni_{0.22}Mn. The x-ray powder diffraction pattern of the product is an essentially amorphous x-ray powder diffraction pattern, showing no Bragg reflections with an I/I₀>1, and only peaks with an I/I₀ less than 0.1 in a range of 54 to 59 2Θ, as shown in FIG. 3.

### Example 2

A solution was prepared in a 1 liter Teflon™ bottle by dissolving NH₄VO₃ (0.02 moles, 2.34 g) in DI water (0.55 moles, 10 grams) and concentrated NH₄OH (2.8 g, 0.024 moles) followed by the addition of KMnO₄ (1 moles, 15.80 g) and (NH₄)₂CO₃ (0.078 moles, 7.5 g). All reactants were mixed together before the bottle was heated at 75° C. for 16 hours with intermittent venting during the digestion. The obtained slurry was then filtered and washed with DI water (3×100 ml) after which the material was dried at 100° C. Elemental analysis of the final product determined the composition to be K_{0.31}V_{0.18}MnN_{0.16}. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 3

A solution was prepared in a 1-L Teflon™ bottle by dissolving Bi(NO₃)₃*5H₂O (0.01 moles, 4.85 grams) in (0.042 moles, 4 g) of HNO₃. The mixture was heated at 70° C. for 10 minutes until there were no precipitates, after which, KMnO₄ (0.1 mole, 15.80 g) followed by the addition of DI water (0.275 moles, 5 g) and (NH₄)₂CO₃ (0.078 moles, 7.5 g). All reactants were mixed before the bottle was heated at 70° C. for 8 hours with intermittent venting during the digestion. The obtained slurry was then filtered and washed with DI water (3×100 ml) after which the material was dried at 100° C. Elemental analysis of the final product determined the composition to be K_{0.17}Bi_{0.1}MnC_{0.23}N_{0.28}. The x-ray powder diffraction pattern of the product is an essentially amorphous x-ray powder diffraction pattern, showing no Bragg reflections with an I/I₀>1, and only peaks with an I/I₀ less than 0.1 in a range of 54 to 59 2Θ, as shown in FIG. 3.

### Example 4

A solution was prepared in a 1-L Teflon™ bottle by dissolving Bi(NO₃)₃*5H₂O (0.005 moles, 2.42 grams) in (0.042 moles, 4 g) of HNO₃. The mixture was heated at 65° C. for 10 minutes until there were no precipitates, after which, KMnO₄ (0.1 mole, 15.80 g) followed by the addition of DI water (0.275 moles, 5 g) and (NH₄)₂CO₃ (0.078 moles, 7.5 g). All reactants were mixed before the bottle was heated at 65° C. for 16 hours with intermittent venting during the digestion. The obtained slurry was then filtered and washed with DI water (3×100 ml) after which the material was dried at 100° C. Elemental analysis of the final product determined the composition to be K_{0.22}Bi_{0.05}MnC_{0.26}N_{0.07}. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 5

A solution was prepared in a 1-L Teflon™ bottle by dissolving Pb(NO₃)₃*5H₂O (0.01 moles, 3.31 grams) in (0.042 moles, 4 g) of HNO₃. The mixture was heated at 75° C. for 10 minutes until there were no precipitates, after which, KMnO₄ (0.1 mole, 15.80 g) followed by the addition of DI water (0.275 moles, 5 g) and (NH₄)₂CO₃ (0.078 moles, 7.5 g). All reactants were mixed before the bottle was heated at 65° C. for 16 hours with intermittent venting during the digestion. The obtained slurry was then filtered and washed with DI water (3×100 ml) after which the material was dried at 100° C. Elemental analysis of the final product determined the composition to be K_{0.21}Pb_{0.11}MnC_{0.21}N_{0.02}. The x-ray powder diffraction pattern of the product is an essentially amorphous x-ray powder diffraction pattern, showing no Bragg reflections with an I/I₀>1, and only peaks with an I/I₀ less than 0.1 in a range of 54 to 59 2Θ, as shown in FIG. 3.

### Example 6

A solution was prepared in a 1-L Teflon™ bottle by dissolving Bi (NO₃)₃*5H₂O (0.01 moles, 4.75 grams) in (0.042 moles, 4 g) of HNO₃. The mixture was heated at 70° C. for 10 minutes until there were no precipitates, after which, Ni(NO₃)₂*6H₂O (0.02 moles, 5.81 g) was added to the solution followed by a solution of KMnO₄ (0.1 mole, 15.80 g) in DI water (0.825 moles, 15 g). (NH₄)₂CO₃ (0.078 moles, 7.5 g) was added to the solution with all reactants were mixed before the bottle was heated at 70° C. for 16 hours with intermittent venting during the digestion. The obtained slurry was then filtered and washed with DI water (3×100 ml) after which the material was dried at 100° C. Elemental analysis of the final product determined the composition to be K_{0.14}Bi_{0.11}Ni_{0.2}MnC_{0.18}N_{0.17}. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 7

A solution was prepared in a 1-L Teflon™ bottle by dissolving Bi(CH₃COO)₃ (0.01 moles, 3.86 grams) in (0.042 moles, 4 g) of HNO₃. The mixture was heated at 70° C. for 10 minutes until there were no precipitates, after which, Ni(NO₃)₂*6H₂O (0.02 moles, 5.81 g) was added to the solution followed by a solution of KMnO₄ (0.1 mole, 15.80 g) in DI water (0.825 moles, 15 g). (NH₄)₂CO₃ (0.078 moles, 7.5 g) was added to the solution with all reactants were mixed before the bottle was heated at 70° C. for 16 hours with intermittent venting during the digestion. The obtained slurry was then filtered and washed with DI water (3×100 ml) after which the material was dried at 100° C. Elemental analysis of the final product determined the composition to be K_{0.1}Bi_{0.1}Ni_{0.21}MnC_{0.36}N_{0.12}. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 8

A solution was prepared in a 1-L Teflon™ bottle by dissolving Pb(NO₃)₃*5H₂O (0.005 moles, 1.17 grams) in (0.042 moles, 4 g) of HNO₃. The mixture was heated at 70° C. for 10 minutes until there were no precipitates, after which, CO(NO₃)₂*6H₂O (0.02 moles, 5.81 g) was added to the solution followed by a solution of KMnO₄ (0.1 mole, 15.80 g) in DI water (0.825 moles, 15 g). (NH₄)₂CO₃ (0.078 moles, 7.5 g) was added to the solution with all reactants were mixed before the bottle was heated at 70° C. for 16 hours with intermittent venting during the digestion. The obtained slurry was then filtered and washed with DI water (3×100 ml) after which the material was dried at 100° C. Elemental analysis of the final product determined the composition to be K_{0.18}Pb_{0.04}Co_{0.2}MnC_{0.11}N_{0.05}. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 9

A solution was prepared by dissolving Bi(NO₃)₃*5H₂O (0.6 moles, 29.1 grams) in (0.315 moles, 30 g) of HNO₃ and DI water (7.2 moles, 130 g) The mixture was heated at 70° C. for 10 minutes until there were no precipitates, after which, Ni(NO₃)₂*6H₂O (0.12 moles, 34.9 g) was added to the solution followed by KMnO₄ (0.6 mole, 94.82 g) and (NH₄)₂CO₃ (0.47 moles, 45 g). The solution was mixed for 1 hour before being transferred to a two liter stirred reactor and digested at 90° C. for 16 hours at 150 rpm. The obtained slurry was then filtered and washed with DI water (3×300 ml) after which the material was dried at 100° C. Elemental analysis of the final product determined the composition to be K_{0.15}Bi_{0.13}Ni_{0.16}MnN_{0.14}. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 10

A solution was prepared in a 1-L Teflon™ bottle by dissolving Cu(NO₃)₃*2.5H₂O (0.02 moles, 4.65 g) in DI water (0.55 moles, 10 grams). KMnO₄ (0.1 mole, 15.80 g) and (NH₄)₂CO₃ (0.078 moles, 7.5 g) were added. All reactants were mixed before the bottle was heated at 65° C. for 16 hours with intermittent venting during the digestion. The obtained slurry was then filtered and washed with DI water (3×100 ml) after which the material was dried at 100° C. Elemental analysis of the final product determined the composition to be K_{0.22}Cu_{0.22}Mn. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 11

A solution was prepared by dissolving Ag(NO₃) (0.01 moles, 1.69 grams) in DI H2O (0.55 moles, 10 grams). KMnO₄ (0.1 mole, 15.80 g) and (NH₄)₂CO₃ (0.078 moles, 7.5 g) were added. All reactants were mixed for 1 hr before being transferred to a two liter stirred reactor and digested at 90° C. for 16 hrs at 150 rpm. The obtained slurry was then filtered and washed with DI H₂O (3×300 ml) after which the material was dried at 100° C. Elemental analysis of the final product determined the composition to be K_{0.24}Ag_{0.05}MnC_{0.4}N_{0.07}. The x-ray powder diffraction pattern of the product is an essentially amorphous x-ray powder diffraction pattern, showing no Bragg reflections with an I/I₀>1, and only peaks with an I/I₀ less than 0.1 in a range of 54 to 59 2Θ, as shown in FIG. 3.

### Example 12

A solution was prepared in a one liter Teflon™ bottle by dissolving Ni(NO₃)₂*6H₂O (0.02 moles, 5.81 g) and Cu(NO₃)₃*2.5H₂O (0.01 moles, 2.33 g) in DI water (0.55 moles, 10 grams followed by the addition of KMnO₄ (0.1 moles, 15.80 g) and (NH₄)₂CO₃ (0.078 moles, 7.5 g). All reactants were mixed together before the bottle was heated at 75° C. for 24 hours with intermittent venting during the digestion. The obtained slurry was then filtered and washed with DI water (3×100 ml) after which the material was dried at 100° C. Elemental analysis of the final product determined the composition to be K_{0.17}Cu_{0.11}Ni_{0.24}MnC_{0.26}N_{0.11}. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 13

A solution was prepared in a one liter Teflon™ bottle by dissolving Bi(NO₃)₃*5H₂O (0.01 moles, 4.85 grams) in (0.042 moles, 4 g) of HNO₃. Next Cu(NO₃)₃*2.5H₂O (0.02 moles, 4.65 g) was added followed by the addition of KMnO₄ (0.1 moles, 15.80 g) and (NH₄)₂CO₃ (0.078 moles, 7.5 g). All reactants were mixed together before the bottle was heated at 55° C. for 48 hours with intermittent venting during the digestion. The obtained slurry was then filtered and washed with DI water (3×100 ml) after which the material was dried at 100° C. Elemental analysis of the final product determined the composition to be K_{0.13}Bi_{0.1}Cu_{0.21}MnC_{0.16}N_{0.07}. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 14

A solution was prepared in a one liter Teflon™ bottle by dissolving Bi(NO₃)₃*5H₂O (0.005 moles, 2.42 grams) in (0.042 moles, 4 g) of HNO₃. Next, KOH (0.05 moles, 2.8 g) was dissolved in DI H2O (0.167, 3 g) after which Cu(NO₃)₃*2.5H₂O (0.04 moles, 9.3 g) was added followed by the addition of KMnO₄ (0.08 moles, 12.64 g) and (NH₄)₂CO₃ (0.1 moles, 9.6 g). All reactants were mixed together before the bottle was heated at 65° C. for 16 hours with intermittent venting during the digestion. The obtained slurry was then filtered and washed with DI water (3×100 ml) after which the material was dried at 100° C. Elemental analysis of the final product determined the composition to be K_{0.03}Bi_{0.07}Cu_{0.49}Mn. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 15

A solution was prepared in a one liter Teflon™ bottle by dissolving Bi(NO₃)₃*5H₂O (0.01 moles, 4.85 grams) in (0.042 moles, 4 g) of HNO and DI water (0.28 moles, 5 g). Next Ni(NO₃)₂*6H₂O (0.02 moles, 5.81 g) and Cu(NO₃)₃*2.5H₂O (0.005 moles, 1.16 g) was added followed by the addition of KMnO₄ (0.1 moles, 15.8 g) and (NH₄)₂CO₃ (0.078 moles, 7.5 g). All reactants were mixed together before the bottle was heated at 70° C. for 16 hours with intermittent venting during the digestion. The obtained slurry was then filtered and washed with DI water (3×100 ml) after which the material was dried at 100° C. Elemental analysis of the final product determined the composition to be Bi_{0.1}Cu_{0.05}Ni_{0.1}Mn. The x-ray powder diffraction pattern of the product is an essentially amorphous x-ray powder diffraction pattern, showing no Bragg reflections with an I/I₀>1, and only peaks with an I/I₀ less than 0.1 in a range of 54 to 59 2Θ, as shown in FIG. 3.

### Example 16

A solution was prepared in a one liter Teflon™ bottle by dissolving Bi(NO₃)₃*5H₂O (0.01 moles, 4.85 grams) in (0.042 moles, 4 g) of HNO and DI water (0.28 moles, 5 g). Next N₁(NO₃)₂*6H₂O (0.02 moles, 5.81 g) and Cu(NO₃)₃*2.5H₂O (0.0042 moles, 2.36 g) was added followed by the addition of KMnO₄ (0.1 moles, 15.8 g) and (NH₄)₂CO₃ (0.078 moles, 7.5 g). All reactants were mixed together before the bottle was heated at 70° C. for 16 hours with intermittent venting during the digestion. The obtained slurry was then filtered and washed with DI water (3×100 ml) after which the material was dried at 100° C. Elemental analysis of the final product determined the composition to be K_{0.02}Bi_{0.1}Cu_{0.1}Ni_{0.2}Mn. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

### Example 17

A solution was prepared in a one liter Teflon™ bottle by dissolving Bi(NO₃)₃.5H₂O (0.01 moles, 4.85 grams) in a solution of HNO₃ (0.042 moles, 4 g) and DI water (5 g, 0.277 moles). The mixture was heated to 65° C. for 10 minutes until there were no precipitates, after which, Ni(NO₃)₂*6H₂O (0.02 moles, 5.81 g) in DI H₂O (10 g, 0.555 moles) was added to the solution followed by KMnO₄ (0.1 mole, 15.80 g) in concentrated NH₄OH (0.15 moles, 16 g). All reactants were mixed before the bottle was heated at 65° C. for 16 hours with intermittent venting during the digestion. The obtained slurry was then filtered and washed with DI water (3×100 ml) after which the material was dried at 100° C. Elemental analysis of the final product determined the composition to be K_{0.1}Bi_{0.1}Ni_{0.19}MnC_{0.29}N_{0.15}. The x-ray powder diffraction pattern of the phase matches the pattern shown in FIG. 3, showing no Bragg reflections with an I/I₀>1, and only peaks with an I/I₀ less than 0.1 in a range of 54 to 59 2Θ.

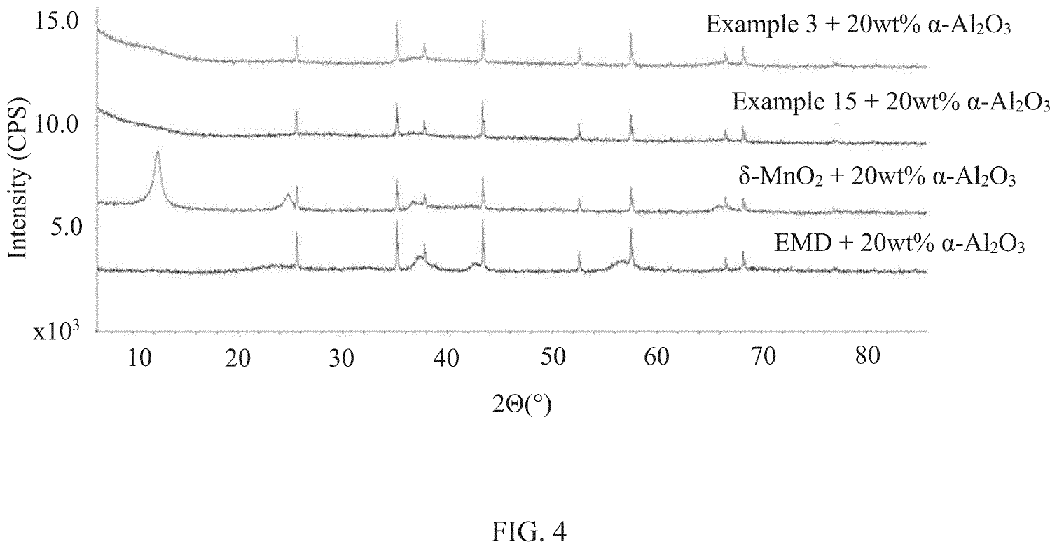

As shown in FIG. 4, Examples 3 and 15 of the present application were compared against EMD and delta-MnO₂. The EMD was purchased as a commercially available material. The delta-MnCO₂ was prepared according to the method described in The synthesis of birnessite, cryptomelane, and some other oxides and hydroxides of manganese, McKenzie, R. M., Mineralogical Magazine, vol. 38, pp. 493-502 (December 1971).

Thus, the present invention is believed to provide a material that is suitable as a cathode material in a rechargeable battery.

### SPECIFIC EMBODIMENTS

While the following is described in conjunction with specific embodiments, it will be understood that this description is intended to illustrate and not limit the scope of the preceding description and the appended claims.

A first embodiment of the invention is a composition comprising a chemical formula of AₐB_{b}C_{c}MₓMn₁₋ₓO_{y}OH_{z}D_{d}, [Chemical Formula 1], wherein A in Chemical Formula 1 is a group I metal, group II metal, ammonium (NH₄⁺), an alkyl ammonium ion, or a quaternary organic cation, or a mixture thereof wherein B in Chemical Formula 1 is bismuth, lead, or a mixture thereof, wherein C in Chemical Formula 1 is copper, silver, gold, or a mixture thereof, wherein M in Chemical Formula 1 is nickel, cobalt, aluminum, scandium, vanadium, chromium, cerium, zinc, or a mixture thereof, wherein D in Chemical Formula 1 is a charge balancing anionic species, wherein a sum of an average valence of A multiplied by ‘a’, an average valence of B multiplied by ‘b’, an average valence of C multiplied by ‘c’, an average valence of M multiplied by ‘x’, and an average valence of Mn multiplied by (1-x) is equal to a sum of 2y, z, and an average valence of D multiplied by ‘d’, wherein ‘a’ is between 0 to 0.4, ‘b’ is between 0 to 0.3, ‘c’ is between 0 to 5, and ‘x’ is between 0 to 0.5, and, wherein the composition includes at least two of A, B, C, and M. An embodiment of the invention is one, any or all of prior embodiments in this paragraph up through the first embodiment in this paragraph wherein A in Chemical Formula 1 is selected from the group consisting of lithium, sodium, potassium, cesium, rubidium, beryllium, magnesium, calcium, strontium, barium, NRC, and mixtures thereof, with R being, hydrogen, an alkyl group, an aryl group, or combinations thereof. An embodiment of the invention is one, any or all of prior embodiments in this paragraph up through the first embodiment in this paragraph wherein the charge balancing anionic species is selected from the group consisting of fluorine (F⁻), chlorine (Cl⁻), bromine (Br⁻), carbonate (CO₃⁻²), nitrate (NO₃⁻¹), sulfide (S²⁻), bisulfide (HS⁻), and mixtures thereof. An embodiment of the invention is one, any or all of prior embodiments in this paragraph up through the first embodiment in this paragraph, wherein C is copper. An embodiment of the invention is one, any or all of prior embodiments in this paragraph up through the first embodiment in this paragraph, wherein c is between 0 and 0.8. An embodiment of the invention is one, any or all of prior embodiments in this paragraph up through the first embodiment in this paragraph, wherein B is bismuth. An embodiment of the invention is one, any or all of prior embodiments in this paragraph up through the first embodiment in this paragraph, wherein M is nickel. An embodiment of the invention is one, any or all of prior embodiments in this paragraph up through the first embodiment in this paragraph, wherein the composition is amorphous. An embodiment of the invention is one, any or all of prior embodiments in this paragraph up through the first embodiment in this paragraph, wherein the composition has an x-ray powder diffraction pattern, showing no Bragg reflections with an I/I₀>1, and only peaks with an I/I₀ less than 0.1 in a range of 54 to 59 2Θ.

A second embodiment of the invention is a composition comprising manganese oxide; copper, silver, gold, or a combination thereof; a first additional cation selected from a group consisting of bismuth, lead, and mixtures thereof; and a second additional cation selected from a group consisting of lithium, sodium, potassium, cesium, rubidium, beryllium, magnesium, calcium, strontium, barium, NR₄⁺, and mixtures thereof, with R being, hydrogen, an alkyl group, an aryl group, or combinations thereof. An embodiment of the invention is one, any or all of prior embodiments in this paragraph up through the second embodiment in this paragraph further comprising a third additional cation selected from a group consisting of nickel, cobalt, aluminum, scandium, vanadium, chromium, cerium, zinc, and mixtures thereof. An embodiment of the invention is one, any or all of prior embodiments in this paragraph up through the second embodiment in this paragraph further comprising a hydroxyl group. An embodiment of the invention is one, any or all of prior embodiments in this paragraph up through the second embodiment in this paragraph, wherein the composition has an essentially amorphous x-ray powder diffraction pattern, showing no Bragg reflections with an I/I₀>1, and only peaks with an I/I₀ less than 0.1 in a range of 54 to 59 2Θ. An embodiment of the invention is one, any or all of prior embodiments in this paragraph up through the second embodiment in this paragraph further comprising a charge balancing anionic species. An embodiment of the invention is one, any or all of prior embodiments in this paragraph up through the second embodiment in this paragraph, wherein the charge balancing anionic species is selected from a group consisting of: fluorine (F⁻), chlorine (Cl⁻), bromine (Br⁻), carbonate (CO₃⁻²), nitrate (NO₃⁻¹), sulfide (S²⁻), bisulfide (HS⁻), and mixtures thereof. An amorphous composition comprising a mixed metal manganese dioxide, wherein the amorphous composition has an essentially amorphous x-ray powder diffraction pattern, showing no Bragg reflections with an I/I₀>1, and only peaks with an I/I₀ less than 0.1 in a range of 54 to 59 2Θ. An embodiment of the invention is one, any or all of prior embodiments in this paragraph up through the second embodiment in this paragraph, wherein the mixed metal manganese dioxide has a chemical formula of AₐB_{b}C_{c}MₓM₁₋ₓO_{y}OH_{z}D_{d}, [Chemical Formula 1], wherein A in Chemical Formula 1 is a group I metal, group II metal, ammonium (NH₄⁺), an alkyl ammonium ion, a quaternary organic cation, or a mixture thereof wherein B in Chemical Formula 1 is bismuth, lead, or a mixture thereof, wherein C in Chemical Formula 1 is copper, silver, gold, or a mixture thereof, wherein M in Chemical Formula 1 is nickel, cobalt, aluminum, scandium, vanadium, chromium, cerium, zinc, or a mixture thereof, wherein D in Chemical Formula 1 is a charge balancing anionic species, wherein a sum of an average valence of A multiplied by ‘a’, an average valence of B multiplied by ‘b’, an average valence of C multiplied by ‘c’, an average valence of M multiplied by ‘x’, and an average valence of Mn multiplied by (1-x) is equal to a sum of 2y, z, and an average valence of D multiplied by ‘d’, wherein ‘a’ is between 0 to 0.4, ‘b’ is between 0 to 0.3; ‘c’ is between 0 to 5, and ‘x’ is between 0 to 0.5; and, wherein the amorphous composition comprises at least two of A, B, C, and M. An embodiment of the invention is one, any or all of prior embodiments in this paragraph up through the second embodiment in this paragraph wherein A in Chemical Formula 1 is selected from a group consisting of lithium, sodium, potassium, cesium, rubidium, beryllium, magnesium, calcium, strontium, barium, NR₄⁺, and mixtures thereof, with R being, hydrogen, an alkyl group, an aryl group, or combinations thereof. An embodiment of the invention is one, any or all of prior embodiments in this paragraph up through the second embodiment in this paragraph wherein the charge balancing anionic species is selected from a group consisting of fluorine (F⁻), chlorine (Cl⁻), bromine (Br⁻), carbonate (CO₃⁻²), nitrate (NO₃⁻¹), sulfide (S²⁻), bisulfide (HS⁻), and mixtures thereof. An embodiment of the invention is one, any or all of prior embodiments in this paragraph up through the second embodiment in this paragraph, wherein C is copper. An embodiment of the invention is one, any or all of prior embodiments in this paragraph up through the second embodiment in this paragraph, wherein c is between 0 and 0.8. An embodiment of the invention is one, any or all of prior embodiments in this paragraph up through the second embodiment in this paragraph, wherein B is bismuth. An embodiment of the invention is one, any or all of prior embodiments in this paragraph up through the second embodiment in this paragraph, wherein M is nickel.

A third embodiment of the invention is a rechargeable battery comprising a housing; an anode material inside the housing; a cathode material inside the housing and electrically separated from the anode material; and, an electrolyte in the housing, wherein the cathode material comprises a mixed metal manganese dioxide an essentially amorphous x-ray powder diffraction pattern, showing no Bragg reflections with an I/I₀>1, and only peaks with an I/I₀ less than 0.1 in a range of 54 to 59 2Θ. An embodiment of the invention is one, any or all of prior embodiments in this paragraph up through the third embodiment in this paragraph, wherein the mixed metal manganese dioxide has a chemical formula of AₐB_{b}C_{c}MₓMn₁₋ₓO_{y}OH_{z}D_{d}, [Chemical Formula 1], wherein A in Chemical Formula 1 is a group I metal, group II metal, ammonium (NH₄⁺), an alkyl ammonium ion, a quaternary organic cation, or a mixture thereof wherein B in Chemical Formula 1 is bismuth, lead, or a mixture thereof, wherein C in Chemical Formula 1 is copper, silver, gold, or a mixture thereof, wherein M in Chemical Formula 1 is nickel, cobalt, aluminum, scandium, vanadium, chromium, cerium, zinc, or a mixture thereof, wherein D in Chemical Formula 1 is a charge balancing anionic species, wherein a sum of an average valence of A multiplied by ‘a’, an average valence of B multiplied by ‘b’, an average valence of C multiplied by ‘c’, an average valence of M multiplied by ‘x’, and an average valence of Mn multiplied by (1-x) is equal to a sum of 2y, z, and an average valence of D multiplied by ‘d’, wherein ‘a’ is between 0 to 0.4, ‘b’ is between 0 to 0.3; ‘c’ is between 0 to 5, and ‘x’ is between 0 to 0.5, and, wherein the mixed metal manganese dioxide comprises at least two of A, B, C, and M. An embodiment of the invention is one, any or all of prior embodiments in this paragraph up through the third embodiment in this paragraph wherein A in Chemical Formula 1 is selected from a group consisting of lithium, sodium, potassium, cesium, rubidium, beryllium, magnesium, calcium, strontium, barium, NR₄⁺, and mixtures thereof, with R being, hydrogen, an alkyl group, an aryl group, or combinations thereof. An embodiment of the invention is one, any or all of prior embodiments in this paragraph up through the third embodiment in this paragraph wherein the charge balancing anionic species is selected from a group consisting of fluorine (F⁻), chlorine (Cl⁻), bromine (Br⁻), carbonate (CO₃⁻²), nitrate (NO₃⁻¹), sulfide (S²⁻), bisulfide (HS⁻), and mixtures thereof. An embodiment of the invention is one, any or all of prior embodiments in this paragraph up through the third embodiment in this paragraph, wherein C is copper. An embodiment of the invention is one, any or all of prior embodiments in this paragraph up through the third embodiment in this paragraph, wherein c is between 0 and 0.8. An embodiment of the invention is one, any or all of prior embodiments in this paragraph up through the third embodiment in this paragraph, wherein B is bismuth. An embodiment of the invention is one, any or all of prior embodiments in this paragraph up through the third embodiment in this paragraph, wherein M is nickel. An embodiment of the invention is one, any or all of prior embodiments in this paragraph up through the third embodiment in this paragraph, wherein the mixed metal manganese oxide comprises manganese oxide; copper, silver, gold, or a combination thereof; a first additional cation selected from a group consisting of bismuth, lead, and mixtures thereof; and a second additional cation selected from a group consisting of lithium, sodium, potassium, cesium, rubidium, beryllium, magnesium, calcium, strontium, barium, NRC, and mixtures thereof, with R being, hydrogen, an alkyl group, an aryl group, or combinations thereof. An embodiment of the invention is one, any or all of prior embodiments in this paragraph up through the third embodiment in this paragraph, wherein the mixed metal manganese oxide further comprises a third additional cation selected from a group consisting of nickel, cobalt, aluminum, scandium, vanadium, chromium, cerium, zinc, and mixtures thereof. An embodiment of the invention is one, any or all of prior embodiments in this paragraph up through the third embodiment in this paragraph, wherein the mixed metal manganese oxide further comprises a hydroxyl group. An embodiment of the invention is one, any or all of prior embodiments in this paragraph up through the third embodiment in this paragraph, wherein the mixed metal manganese oxide further comprises a charge balancing anionic species. An embodiment of the invention is one, any or all of prior embodiments in this paragraph up through the third embodiment in this paragraph, wherein the charge balancing anionic species is selected from a group consisting of fluorine (F⁻), chlorine (Cl⁻), bromine (Br⁻), carbonate (CO₃⁻²), nitrate (NO₃⁻¹), sulfide (S²⁻), bisulfide (HS⁻), and mixtures thereof.

A fourth embodiment of the invention is a method for forming a composition having a chemical formula of AₐB_{b}C_{c}MₓMn₁₋ₓO_{y}OH_{z}D_{d}, [Chemical Formula 1], wherein A in Chemical Formula 1 is a group I metal, group II metal, ammonium (NH₄⁺), alkyl ammonium ion, a quaternary organic cation, or a mixture thereof, wherein B in Chemical Formula 1 is bismuth, lead, or a mixture thereof, wherein C in Chemical Formula 1 is copper, silver, gold, or a mixture thereof, wherein M in Chemical Formula 1 is nickel, cobalt, aluminum, scandium, vanadium, chromium, cerium, zinc, or a mixture thereof, wherein D in Chemical Formula 1 is a charge balancing anionic species, wherein a sum of an average valence of A multiplied by ‘a’, an average valence of B multiplied by ‘b’, an average valence of C multiplied by ‘c’, an average valence of M multiplied by ‘x’, and an average valence of Mn multiplied by (1-x) is equal to a sum of 2y, z, and an average valence of D multiplied by ‘d’, wherein ‘a’ is between 0 to 0.4, ‘b’ is between 0 to 0.3; ‘c’ is between 0 to 5 and ‘x’ is between 0 to 0.5, and wherein the composition comprises at least two of A, B, C, and M, and the method comprising forming a slurry mixture comprising protic solvent and a source for each of Mn, A, B, C, and M; reacting the slurry mixture at elevated temperature with an autogenous pressure; and, then recovering a material comprising the composition from the slurry mixture. An embodiment of the invention is one, any or all of prior embodiments in this paragraph up through the fourth embodiment in this paragraph, wherein the elevated temperature is from 10° C. to about 150° C. An embodiment of the invention is one, any or all of prior embodiments in this paragraph up through the fourth embodiment in this paragraph, wherein the slurry mixture is held at a temperature in a range from 10° C. to about 150° C. for a period of time in a range from 30 minutes to 14 days.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A composition comprising:
a chemical formula of:
AₐB_{b}C_{c}MₓM₁₋ₓO_{y}OH_{z}D_{d}, [Chemical Formula 1],
wherein A in Chemical Formula 1 is a group I metal, group II metal, ammonium (NH₄⁺), an alkyl ammonium ion, a quaternary organic cation, or a mixture thereof
wherein B in Chemical Formula 1 is bismuth, lead, or a mixture thereof,
wherein C in Chemical Formula 1 is copper, silver, gold, or a mixture thereof,
wherein M in Chemical Formula 1 is nickel, cobalt, aluminum, scandium, vanadium, chromium, cerium, zinc, or a mixture thereof,
wherein D in Chemical Formula 1 is a charge balancing anionic species,
wherein a sum of an average valence of A multiplied by ‘a’, an average valence of B multiplied by ‘b’, an average valence of C multiplied by ‘c’, an average valence of M multiplied by ‘x’, and an average valence of Mn multiplied by (1-x) is equal to a sum of 2y, z, and an average valence of D multiplied by ‘d’,
wherein ‘a’ is between 0 to 0.4, ‘b’ is between 0 to 0.3, ‘c’ is between 0 to 5, and ‘x’ is between 0 to 0.5, and,
wherein the composition includes at least two of A, B, C, and M.

2. The composition of claim 1 wherein A in Chemical Formula 1 is selected from the group consisting of: lithium, sodium, potassium, cesium, rubidium, beryllium, magnesium, calcium, strontium, barium, NR₄⁺, and mixtures thereof, with R being, hydrogen, an alkyl group, an aryl group, or combinations thereof.

3. The composition of claim 1 wherein the charge balancing anionic species is selected from the group consisting of: fluorine (F⁻), chlorine (Cl⁻), bromine (Br⁻), carbonate (CO₃⁻²), nitrate (NO₃⁻¹), sulfide (S²⁻), bisulfide (HS⁻), and mixtures thereof.

4. The composition of claim 1, wherein C is copper.

5. The composition of claim 1, wherein c is between 0 and 0.8.

6. The composition of claim 1, wherein B is bismuth.

7. The composition of claim 1, wherein M is nickel.

8. The composition of claim 1, wherein the composition is amorphous.

9. The composition of claim 8, wherein the composition has an x-ray powder diffraction pattern, showing no Bragg reflections with an I/I₀>1, and only peaks with an I/I₀ less than 0.1 in a range of 54 to 59 2Θ.

10. A composition comprising:
manganese oxide;
copper, silver, gold, or a combination thereof;
a first additional cation selected from a group consisting of:
bismuth, lead, and mixtures thereof; and
a second additional cation selected from a group consisting of:
lithium, sodium, potassium, cesium, rubidium, beryllium, magnesium, calcium, strontium, barium, NR₄⁺, and mixtures thereof, with R being, hydrogen, an alkyl group, an aryl group, or combinations thereof.

11. The composition of claim 10 further comprising:
a third additional cation selected from a group consisting of:
nickel, cobalt, aluminum, scandium, vanadium, chromium, cerium, zinc, and mixtures thereof.

12. The composition of claim 10 further comprising a hydroxyl group.

13. The composition of claim 10, wherein the composition has an essentially amorphous x-ray powder diffraction pattern, showing no Bragg reflections with an I/I₀>1, and only peaks with an I/I₀ less than 0.1 in a range of 54 to 59 2Θ.

14. The composition of claim 10 further comprising:
a charge balancing anionic species.

15. The composition of claim 14, wherein the charge balancing anionic species is selected from a group consisting of: fluorine (F⁻), chlorine (Cl⁻), bromine (Br⁻), carbonate (CO₃⁻²), nitrate (NO₃⁻¹), sulfide (S²⁻), bisulfide (HS⁻), and mixtures thereof.

16. A rechargeable battery comprising:
a housing;
an anode material inside the housing;
a cathode material inside the housing and electrically separated from the anode material; and,
an electrolyte in the housing,
wherein the cathode material comprises:
a mixed metal manganese dioxide having an essentially amorphous x-ray powder diffraction pattern, and showing no Bragg reflections with an I/I₀>1, and only peaks with an I/I₀ less than 0.1 in a range of 54 to 59 2Θ.

17. The rechargeable battery of claim 16, wherein the mixed metal manganese dioxide has a chemical formula of
AₐB_{b}C_{c}MₓM₁₋ₓO_{y}OH_{z}D_{d}, [Chemical Formula 1],
wherein A in Chemical Formula 1 is a group I metal, group II metal, ammonium (NH₄⁺), an alkyl ammonium ion, a quaternary organic cation, or a mixture thereof
wherein B in Chemical Formula 1 is bismuth, lead, or a mixture thereof,
wherein C in Chemical Formula 1 is copper, silver, gold, or a mixture thereof,
wherein M in Chemical Formula 1 is nickel, cobalt, aluminum, scandium, vanadium, chromium, cerium, zinc, or a mixture thereof,
wherein D in Chemical Formula 1 is a charge balancing anionic species,
wherein a sum of an average valence of A multiplied by ‘a’, an average valence of B multiplied by ‘b’, an average valence of C multiplied by ‘c’, an average valence of M multiplied by ‘x’, and an average valence of Mn multiplied by (1-x) is equal to a sum of 2y, z, and an average valence of D multiplied by ‘d’,
wherein ‘a’ is between 0 to 0.4, ‘b’ is between 0 to 0.3; ‘c’ is between 0 to 5, and ‘x’ is between 0 to 0.5, and,
wherein the mixed metal manganese dioxide comprises at least two of A, B, C, and M.

18. The rechargeable battery of claim 17, wherein A in Chemical Formula 1 is selected from a group consisting of: lithium, sodium, potassium, cesium, rubidium, beryllium, magnesium, calcium, strontium, barium, NR₄⁺, and mixtures thereof, with R being, hydrogen, an alkyl group, an aryl group, or combinations thereof.

19. The rechargeable battery of claim 17, wherein the charge balancing anionic species is selected from a group consisting of: fluorine (F⁻), chlorine (Cl⁻), bromine (Br⁻), carbonate (CO₃⁻²), nitrate (NO₃⁻¹), sulfide (S²⁻), bisulfide (HS⁻), and mixtures thereof.

20. The rechargeable battery of claim 16, wherein the mixed metal manganese oxide comprises:
manganese oxide;
copper, silver, gold, or a combination thereof;
a first additional cation selected from a group consisting of:
bismuth, lead, and mixtures thereof; and
a second additional cation selected from a group consisting of:
lithium, sodium, potassium, cesium, rubidium, beryllium, magnesium, calcium, strontium, barium, NR₄⁺, and mixtures thereof, with R being, hydrogen, an alkyl group, an aryl group, or combinations thereof.
